(19) United States
(12) Patent Application Publication
(10) Pub. No.: US 2015/0161252 A1
(43) Pub. Date: Jun. 11, 2015

(54) VIDEO RETRIEVAL

(71) Applicant: Hewlett-Packard Development Company, L.P., Houston, TX (US)

(72) Inventors: Pam Lennan, San Diego, CA (US); Sabrina Kwan, San Diego, CA (US); Steven Say, San Diego, CA (US); Elaine Yan Chi Yuan, San Diego, CA (US); Shamil Mahendra Hargovan, Sunnyvale, CA (US); James L. McCullough, San Diego, CA (US)

(73) Assignee: Hewlett-Packard Development Company, L.P., Houston, TX (US)

(21) Appl. No.: 14/101,664

(22) Filed: Dec. 10, 2013

(51) Int. Cl. G06F 17/30

(52) U.S. Cl. CPC G06F 17/30784; G06F 17/3084

(57) ABSTRACT

An example processor-implemented method for retrieving multimedia data in accordance with the present disclosure is determining whether each of a plurality of still frames satisfies at least one trigger qualification process for a trigger generation process, presenting for selection still frames from the plurality of still frames if the still frames satisfy the at least one trigger qualification process for a trigger generation process, receiving a selection of a still frame from among the presented still frames, and performing the trigger generation process on the selected still frame to generate a trigger for the selected still frame.

### BACKGROUND

With the Internet, the amount of multimedia content that can be accessed by the public has significantly grown. There are occasions where a user who once accessed particular multimedia content needs or desires to access the content again at a later time, possibly at or from a different place. Moreover, a user may decide to share multimedia content with another user. For example, a user may choose to share photos by publishing or transferring the user's digital photos that enables the user to share them with others either publicly or privately.

### BRIEF DESCRIPTION OF THE DRAWINGS

Examples are described in the following detailed description and in reference to the drawings, in which:

FIG. 1 illustrates an example system in accordance with an implementation;

FIGS. 2A, 2B, and 2C illustrate example user interfaces of a video application in accordance with an implementation;

FIG. 3 illustrates an example system of a video application in accordance with an implementation; and

FIG. 4 illustrates an example computing device in accordance with an implementation; and

FIG. 5 illustrates an example process flow diagram in accordance with another implementation.

### DETAILED DESCRIPTION

Various aspects of the present disclosure are directed to retrieving a video. More specifically, and as described in greater detail below, various aspects of the present disclosure are directed to a manner by which a video is retrieved through a link between the video and a still frame extracted from the video. Aspects of the present disclosure described herein allow one user to share a video with another user by providing the still frame extracted from the video in various forms, including printed form.

Moreover, aspects of the present disclosure described herein also disclose using a trigger, which may be a packet or other element of data derived from characteristics of the still frame extracted from the video and that can be sent to a server and used as a means to retrieve the video from a database. Among other things, this approach allows the user to share video with another user by using an unmarked, clean still image frame.

Further, aspects of the present disclosure described herein allow the user to select the still frame from the video. Accordingly, the selected still frame may act as a reminder of what video is shared. Among other things, this approach may prevent the user from sharing the wrong video and may provide a more customized experience to the user.

In one example in accordance with the present disclosure, a method for retrieving a video is provided. The method comprises determining whether each of a plurality of still frames satisfies at least one trigger qualification process for a trigger generation process, presenting for selection still frames from the plurality of still frames if the still frames satisfy the at least one trigger qualification process for a trigger generation process, receiving a selection of a still frame from among the presented still frames, and performing the trigger generation process on the selected still frame to generate a trigger for the selected still frame.

In another example in accordance with the present disclosure, a system is provided. The system comprises a quality engine to perform a qualification process for a trigger generation process, an extraction engine to extract still frames from the video, a display engine to display, in a graphical user interface (GUI) for selection, still frames qualified by the qualification process, a communication engine to receive a selection of one of the displayed still frames via the GUI, and a generation engine to perform the trigger generation process on the selected still frame to generate a trigger for the selected still frame.

In a further example in accordance with the present disclosure, a non-transitory computer readable medium is provided. The non-transitory computer-readable medium comprises instructions which, when executed, cause a device to (i) extract a plurality of still frames from a selected portion of a video, (ii) determine whether each of the plurality of still frames satisfies at least one trigger qualification process for a trigger generation process, (iii) present for selection still frames from the plurality of still frames determined to satisfy the at least one trigger qualification process, (iv) receive a selection of a still frame from among the presented still frames, and (v) perform the trigger generation process on the selected still frame to generate a trigger for the selected still frame.

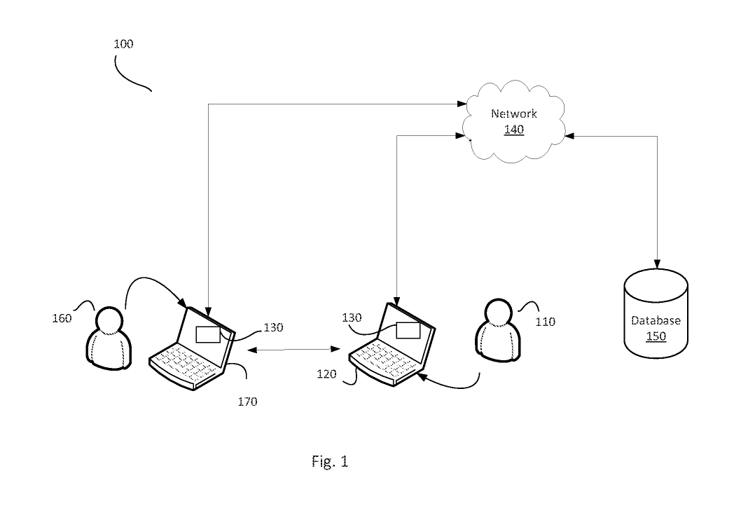

FIG. 1 illustrates an example system 100 in accordance with an implementation. It should be readily apparent that the present illustration should not be interpreted to be limited by this particular illustrative architecture shown in FIG. 1, and the system 100 represents a generalized illustration and that other elements may be added or the illustrated elements may be removed, modified, or rearranged in many ways. For example, while the system 100 depicted in FIG. 1 includes only two multimedia devices, the system may actually comprise any number of multimedia devices, and only two have been shown and described for simplicity. The system 100 comprises computing devices 120 and 170, video application 130, a computer network 140 (or “network” 140), and a database server 150.

The system 100 may be a cloud-based sharing system, which uses computing resources (hardware and software) that are delivered as a service over a network (e.g., the Internet). The cloud-based system exposes data to be accessed by computing devices as a service over a network (e.g., network 140), and accordingly the computing devices may be connected to each other through the cloud. Cloud resources accessible via network 140 may replace, supplement, or blend with features and capabilities provided by applications and software that run locally. Applications may include, for example, one or more of identity and directory services, device management and security, synchronized storage and data services across multiple devices or platforms, and services pertaining to activities and news. Moreover, the computing devices 120 and 170 along with the video application 130 may be connected to the database server 150 and/or each other through network 140. The network 140 may comprise one or more local area networks, wide area networks, virtual private networks, the Internet, or the like, or a combination thereof.

In other example implementations, the system 100 may be peer-to-peer sharing environment, in which there may be distributed architecture without the need for central coordination, with user multimedia devices being at the same time both suppliers and consumers of data objects. Peer-to peer (P2P) technology creates a means for sharing information without requiring that all information be saved on a central, hosted server, providing direct connections between data sources and offered either access to files or replication of files.

The communications medium interconnecting the computing devices may include any combination of wired and/or wireless resources. For example, the communications medium may include resources provided by any combination of cable television networks, direct video broadcasting networks, satellite networks, cellular networks, wired telephony networks and/or data networks, wireless data networks (e.g., wireless local area networks, wireless personal area networks, etc.), and so forth. The computing devices need not be continuously connected.

The computing devices 120 and 170 may be any device capable of processing content information, interacting with a corresponding content stream, and communicating over the network. The computing devices 120 and 170 may be further capable of supporting various operations, such as and not limited to, content viewing, content recording, content play, content forwarding/rewinding, content downloading, content uploading, etc. In another implementation, the computing devices 120 and 170 may be provided with credentials for accessing/receiving content.

The computing devices 120 and 170 may be intended to be representative of a broad category of data processors. As used herein, a “computing device” may be a desktop computer, notebook computer, workstation, tablet computer, mobile phone, smart device, server, or any other processing device or equipment. Any computing device described herein (including computing devices 120 and 170) may include a processor and memory. Depending on the implementation, security features/tools may be implemented in various ways such as by a firewall, one time passwords, encryption programs, digital certificates, user application security, etc. Various combinations of these and/or other security features may be used. In some implementations, these security approaches may be layered to provide a highly secure environment in which one device may interact with another. For example, the security features may require a user to log in before transferring data from one device to another. In other implementations, the security features may require the user to provide the users credentials or identity which is trusted by the cloud for transferring data over the cloud.

In the illustrated example implementation, the user 110 interacts with the computing device 120 and the user 160 interacts with the computing device 170.

In the example of FIG. 1, the computing device 120 may comprise an instance of the video application 130, which it may execute or which may run on each of the computing devices 120 and 170. In one implementation, the video application 130 may perform functionalities of a creation module. The video application 130 may also have additional functionalities such as functionalities of a viewing module.

In some example implementations, the video application 130 may request information about the user 110 that is associated with the video application 130. Further, the video application 130 may request information about the user 170. In example implementations, user information may include a users credentials such as, and not limited to, a user name, password, email address, profile photo, and other privacy/security settings. User information may also include, and not limited to, a users first name, family name, gender, age, address, country, spoken languages, job type, employer, schools, affiliations, etc.

The video application 130 may implement a user interface (UI) that application 130 may output (e.g., display) on a display of the computing device 120. In one example system, such user interface may present various pages that represent functionalities available to the user 110. The user interface may facilitate interactions between the user 110 and the video application 130 by inviting and responding to user input and translating tasks and results to a language or image that the user 110 can understand. For example, the user 110 may capture or otherwise provide video data (e.g., a video file) to the video application 130.

In some implementations, the video files may be retrieved from a video/photo storage application on the computing device 120. In other implementations, the video files may be retrieved from a video database, for instance.

In some examples, the video application 130 may show, via the user interface, video files to the user 110 for selection. The user 110 may select a video file from the presented video files by providing input to the user interface via an appropriate input device. For example, the user 110 may interact with the video application 130 by controlling an input device for the computing device 120 such as a keyboard, a mouse, a touch-sensitive display (e.g., touchscreen), microphone, or the like, or a combination thereof.

In an alternative implementation, a video file may be created using a plurality of video data from a number of users or user devices. For instance, a plurality of users may use their mobile devices to record digital videos. Alternatively, in another example, one user may record a plurality of digital videos on one mobile device. The plurality of video files may be sent and/or gathered at one computing device via a communication link, e.g., via a wireless network connection. The plurality of video files can be merged into one video file, e.g., containing all of the video files. In some examples, an application, e.g., a mobile application may be used for the creation of the plurality of video files and the sending and/or gathering of the plurality of video files.

For example, the user 110 may use the computing device 120 to create a video file, e.g., record a video. For instance, the user 110 may record a birthday greeting. Other users (not shown in FIG. 1) may also record birthday greetings. In some examples, the video file may be created on a device other than the computing device 120 and may be sent to the computing device 120, e.g., via a communication link. In the example, the other users may send their video greetings to the user 110, e.g., via a wireless connection, 3G connection, 4G connection, etc. In such an example, the user 110 can be referred to as an authoring client.

In one implementation, the user 110 may select a certain portion of the video file via the user interface. In some examples, the video application 130 may generate a trigger from a still frame of the selected video and associate that trigger with the video in a remote database. Based on the selected portion of the video file, the video application 130 may qualify a plurality of still images (e.g., still frames) from the video file. The plurality of qualified still frames may be presented to the user 110, and the user 110 may select a still frame out of the plurality of still frames to be used by the video application 130 to generate a trigger to be associated with the video.

Alternatively, in the example where the user 110 receives a plurality of video files (i.e., video greetings) from other users, the application 130 of the user 110 may extract a representative still frame from each of the video greetings. For example, the representative still frames can be extracted in a number of ways. The user 110 may merge the videos into one video file containing all of the video greetings. From that, one still frame may be selected. Accordingly, one trigger may be created based on that one selected still frame (which will be described in more detail below). Alternatively, the user 110 may extract a representative still frame from each one of the individual video greetings, and as a result, have multiple representative still frames. The user 110 may use the application and multiple representative still frames to create one still frame. In an example where multiple still images are used, the user 110 can choose a background, and the multiple still frames may be merged into the background. For instance, the background may be related to the type of video file. If the users record birthday greeting videos, a birthday-themed background may be used.

The video application 130 may use the still frame to generate a trigger to be associated with the video. The trigger may be a packet or other element of data derived from characteristics of the still frame extracted from the video and that can be used as a means, e.g. as a key, to retrieve the video from a database.

In one implementation, the video application 130 may select the plurality of still frames (i.e., still images) to present to the user for selection based on a qualification process. More specifically, the video application 130 may search for still frames of the video, from which a suitable trigger may be generated and that therefore qualify for a trigger generation process. For example, the video application 130 may apply a set of trigger qualification metric(s) to still frames of the video. For the qualification process, the video application 130 may consider various characteristics of a still frame, for instance flat area distribution, shadow levels, and/or black and white color ratio of the still frame. These characteristics may be determined for the image and compared, either singly or in combination, with one or more thresholds. In one implementation, the video application 130 performing the qualification process may determine using this process that certain still frames are less suitable for trigger generation and do not qualify for the trigger generation process. Still frames comprising sparse images (e.g., basic logos), dark images (e.g., images with no or little tonal variation), images with repeated and identical features (e.g., a glass building), blurred images (including gradients) or reflective images (e.g., a glass building) may for instance not be suitable for trigger generation. Moreover, in some examples, the video application 130 performing the qualification process may determine that certain still frames do qualify for the trigger generation process, such as still frames comprising threshold levels of certain qualities such as tonal variation and contrast, or frames that include unique shapes and forms.

In one implementation, the video application 130 may determine that some of the still frames do not qualify for the trigger generation process, and accordingly, eliminate the non-qualifying frames from consideration. In some example implementations, the video application 130 may crop a non-qualifying still frame to eliminate areas with no or little information. Further, the video application 130 may extract the qualifying plurality of still frames, and as mentioned earlier, present such still frames to the user 110.

In some alternative example implementations, the video application 130 may perform the qualification process after the extraction of the still frames from the video file. In these examples, the video application 130 may, for instance, automatically extract one still frame out of a set number of frames (e.g., one frame out of six). Once extracted, the video application 130 may check whether the extracted still frames qualify for the trigger generation process. In the event that the still frame does not qualify, the video application 130 may remove the non-qualifying still frames from the plurality of still frames that are extracted from the video. In the event that the video application 130 cannot identify any qualifying still frames in the selected portion of the video file, the video application 130 may alert the user 110 of that and inform the user that a new portion of the video may be selected.

In one example implementation, as mentioned earlier, the user 110 may select a still frame out of the plurality of qualified still frames to be used by the video application 130. The video application 130 may create a trigger based upon the selected still frame. The trigger may be stored in the database 150 along with the video and may associate the still frame with the video from which the still frame is extracted. The trigger for the still frame may comprise a collection of information output by a given encoding technique when applied to the still image. In some instances, the encoding technique may use various features of the still image to generate the trigger, and accordingly, the trigger may comprise encoded information related to various features of the still frame. For example, the trigger may be derived from a collection of visual information and/or characteristic information of the still frame. Such information may include geometric features (e.g., flat area distribution), color patterns (e.g., shadow levels), and/or color information associated with shapes and/or objects (e.g., black and white color ratio). Further, the trigger may reflect distinctive features of the frame such as shapes, dot-to-dot type X-Y coordinates of the shapes, patterns colors, letters numbers, symbols, etc. associated with objects/points of interest in the still frame. As a part of the trigger generation process, the video application 130 may analyze the still frames to identify the characteristics and/or visual information of the still frames. In one example implementation, the video application 130 may use object recognition technology as its trigger generation process to extract distinctive features within the still frames and gather the information related to the characteristics discussed above.

Alternatively, in another example, a plurality of triggers may be created. For example, in the implementation where the user 110 receives a plurality of video files (i.e., video greetings), the application 130 of the user 110 may extract a representative still frame from each of the video files. Based on each representative still frames, the application 130 may create a trigger for each video. For example, a first trigger associated with a first representative still frame associated with a first video and a second trigger associated with a second representative still frame associated with a second video may be created.

In one example implementation, the database 150 may contain data including, but not limited to, video files and still frames. In addition, the database server 150 may contain data related to triggers, and the triggers can be used by the database server to retrieve the associated video files. For example, the first video file and the second video file may be indexed in the database 150 using the first trigger and the second trigger. In addition, the first representative still frame can be linked to the first video file within the remote database using the first trigger, and the second representative still frame can be linked to the second video file within the remote database using the second trigger.

In some example implementations, the database 150 may contain personal content associated with a user. While FIG. 1 illustrates a single database, the database 150 may be configured differently in other examples. For example, the database 150 may be split into more than one database or distributed or mirrored over multiple systems. According to an example implementation, the database 150 may contain a sub-database. In one implementation, the database 150 may be connected to the computing devices 120 and 170. In another implementation, the database 150 may be stored locally at the premises of the computing devices 120 or 170 and content may be provided with one or more suitable interfaces.

The personal content referred to herein may, for instance, be a collection of personal assets which may include videos from local systems, social networks, other internet sources (e.g., blogs, microblogging sites), RSS feeds, and/or emails. Further, video content may be in a format of MPEGx, H.264, AVS, AVI, etc., or any other suitable format. The still frames may be in, for example, JPEG, TIF or PDF format, or any other suitable format.

The video application 130 may comprise a user interface on the computing device 170. Such interface may allow the user 160 to interact with the video application 130. For example, using the user interface in the video application 130, the user 160 may view on the computing device 170 the still frame selected by the user 110.

In various example implementations, the user 110 may share the still frame with the user 160 in different ways. For example, the user 110 may distribute the still frame to the user 160 in a digital copy or hardcopy. More specifically, the hardcopy of the still frame may be a copy of the still frame printed on physical media, such as paper, etc. A digital copy of the still frame may be the still frame file viewed in an electronic environment. In one example implementation, the user 110 may invite the user 160 to view a digital copy of the still frame using, by way of example and without limitation, an email address, a social network platform or application, an instant messaging application, an electronic mail (email) application, a voice over IP (VoIP) application, a gaming application, online discussion groups and blogging forums, etc. In another example implementation, the user 110 may have a printed version of the still frame and share the hardcopy of the still frame with the user 160. The user 160 may obtain (e.g., receive from the first user) the hardcopy of the still frame, and use a camera in the computing device 170 to capture an image of (i.e., take a digital photograph of) the still frame.

In some example implementations, the video application 130 may review the image captured by the camera in the computing device 170 and generate a trigger from the captured image. The video application 130 may send the trigger to database server 150. The database server 150 then may determine whether a matching trigger may be found in the database. If a matching trigger is found, the video associated with the matching trigger may be retrieved. Such video may correspond to the video selected by the user 110 on the computing device 120. The database server 150 may deliver the video file to the computing device 170 for the user 160 to view.

In other example implementations, the video application 130 in the computing device 170 may have access to the trigger generated in the computing device 120 (e.g., the trigger may be downloaded to the computing device 170 from the computing device 120 or the database 150). Accordingly, the video application 130 may compare the trigger generated in the computing device 120 with the trigger generated in the computing device 170. If the triggers match, the video file associated with the trigger may be retrieved from the database 150.

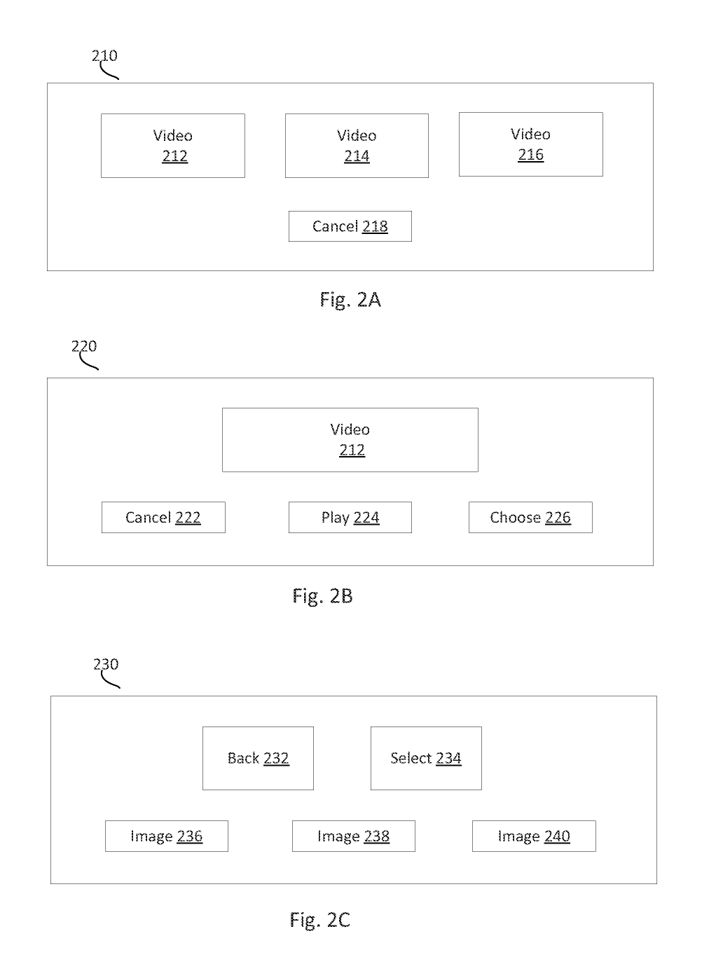

FIGS. 2A, 2B and 2C illustrate user interfaces 210, 220 and 230 of the video application 130 in accordance with an example implementation. It should be readily apparent that the user interfaces illustrated in FIGS. 2A, 2B and 2C represent generalized depictions and that other components may be added or existing components may be removed, modified, or rearranged in many ways. The user interfaces 210, 220 and 230 described herein may comprise a number of user interface components, each with a particular role, as shown in FIGS. 2A, 2B and 2C. These modules can be either functions within the computer program product described herein, sub-methods of the method described herein, and/or elements of the system described herein, for instance.

FIG. 2A illustrates the user interface 210 of the video application 130 on the computing device 120 shown in FIG. 1 in accordance with an example implementation. The user interface 210 shown comprises video files 212, 214 and 216. The user 110 may interact with the interface 210 to select one of the video files 212, 214 and 216. It should be noted that while the user interface 210 depicted in FIG. 2A includes three video files, the interface 210 may actually comprise more or fewer video files, and three files have been shown and described for simplicity. In one example implementation, the files 212, 214 and 216 may be provided by the user 110. For example, the files 212, 214 and 216 may be pulled from a video storage application on the computing device 120. In another example implementation, the files 212, 214 and 216 may be provided from an outside source. The user 110 may choose from a list of available files to initiate the process for sharing the selected file. For example, if the user clicks on the file 212, the file 212 may be selected to be shared with another user. In some implementations, the user 110 may choose to terminate the sharing process, and may click on cancel button 218. In one example implementation, clicking on cancel button 218 may close the user interface 212 of the video application 130.

FIG. 2B illustrates the user interface 220 of the video application 130 on the computing device 120 in accordance with an implementation. The user interface 220 comprises video file 212, cancel button 222, play button 224 and choose button 226. The user interface 220 may be populated based on the selection entered by the user on the user interface 210 (as shown in FIG. 2A). For example, the user interface 220 displays the multimedia file 212 as a result of the user 110's selection of the multimedia file 212. In one implementation, the user interface 220 provides the functionality of previewing and editing (e.g., cutting) a video file for the user 110 to select a portion of the video file. The user may click on play button 224, and the video 212 may start playing. While previewing the video, the user 110 may pause the video to select a portion of the video by clicking on choose button 226. In another implementation, the user 110 may click on cancel button 222 to terminate the process.

FIG. 2C illustrates the user interface 230 of the video application 130 on the computing device 120 in accordance with an implementation. The user interface 230 comprises still frames 236, 238 and 240, a back button 232, and a select button 234. The video application 130 may extract frames (e.g., the still frames 236, 238 and 240) from the video portion selected by the user 110. It should be noted that while the user interface 230 depicted in FIG. 2C includes three still frames (i.e., the still frames 236, 238 and 240), the interface 230 may actually comprise more or fewer still frames, and three files have been shown and described for simplicity.

In one example implementation, the video application 130 may identify the still frames 236, 238 and 240 based on a trigger qualification metric. Further, the user 110 may click on one of the frames 236, 238 and 240 and click on the select button 234. In another example implementation, the user 110 may not like any of the frames presented and may decide to select a different portion of the multimedia file 212 to view new frames. In that situation, the user 110 may click on the back button 232 to return to the user interface 220.

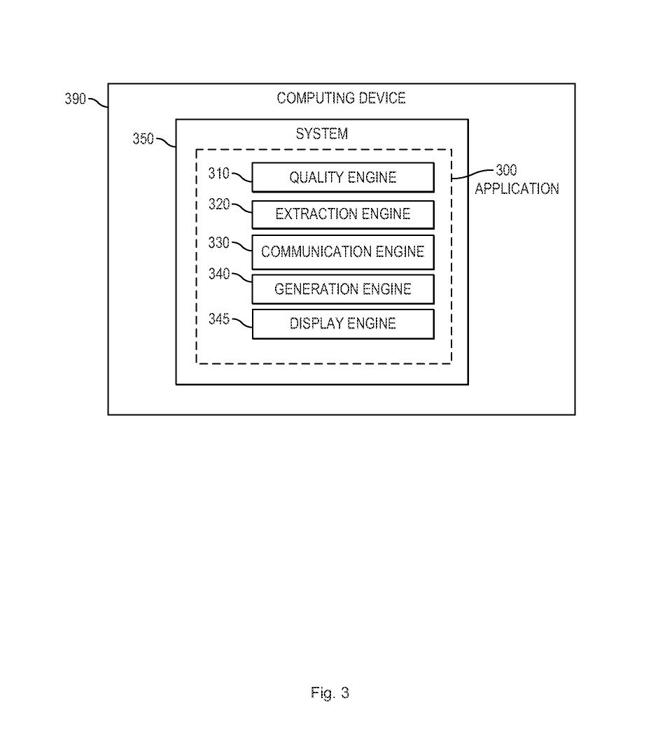

FIG. 3 illustrates an example of a system 350 to implement a video application 300. The system 350 illustrated in FIG. 3 includes various engines to implement the functionalities described herein. The system 350 may include at least a quality engine 310, an extraction engine 320, a communication engine 330, a generation engine 340 and a display engine. Although the various engines 310-345 are shown as separate engines in FIG. 3, in other implementations, the functionality of all or a subset of the engines 310-345 may be implemented as a single engine. In some examples, video application 300 implemented by system 350 may perform any combination of the functionalities described above in relation to application 130 of FIG. 1.

Each of the engines of system 350 may be any suitable combination of hardware and programming to implement the functionalities of the respective engine. Such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement system 350. The machine-readable storage medium storing the instructions may be integrated in a computing device including the processing resource to execute the instructions, or the machine-readable storage medium may be separate but accessible to the computing device and the processing resource. The processing resource may comprise one processor or multiple processors included in a single computing device or distributed across multiple computing devices. In other examples, the functionalities of any of the engines may be implemented in the form of electronic circuitry. The video application 300 may comprise a qualification engine 310. The qualification engine 310 may review still frames identified in a portion of a video identified by a user. Based on the review, the qualification engine 310 may determine whether the still frames satisfy a trigger qualification metric. The qualification metric may be related to a trigger generation process, which may require a certain amount of flat area distribution, shadow levels, and/or black and white color ratio. Accordingly, the qualification engine 310 may consider various features of the still frames based on the trigger quality metric that may be necessary for the trigger generation process.

In one implementation, the qualification engine 310 may conclude that some of the still frames may not be qualified for the trigger generation process, and accordingly, eliminate those non-qualifying still frames. In the event that there are no qualifying frames in the portion of the video selected by the user, the qualification engine 310 may alert the user to select a new portion of the video.

The video application 300 may comprise an extraction engine 320. The extraction engine 320 may extract all the still frames that the qualification engine 310 identified as qualified for the trigger generation process. The user may select one of the qualifying still frames.

Moreover, the video application 300 may comprise a communication engine 330. The communication engine 330 may receive the still frame that the user selected from the qualifying still frame options, and make the still frame available to a generation engine 340. The generation engine 340 may create a trigger based upon the selected still frame. In one implementation, the generation engine 340 may create the trigger by utilizing an algorithm which considers various characteristics of the still frame. More specifically, the generation engine 340 may use an algorithm to identify the characteristics of the still frame and extract those characteristics, along with the geographical information, and other relevant information. As stated above, the characteristics may include, for example, shapes (e.g., flat area distribution), dot-to-dot type X-Y coordinates of the shapes, patterns, colors (e.g., shadow levels, black and white color ratio), letters, numbers, and/or symbols. In particular, the above mentioned information related to the still frame may be input into the algorithm, from which the trigger may be output. The trigger associated with the still frame may be used by video applications to retrieve the video.

Further, the video application 300 may comprise a display engine 345. The display engine 345 may be used to play video files and to show still frames to a user of the system 350. In an alternative example, where the user may use a plurality of video files, the plurality of video files can be viewed via the displayed engine 345. When the merged video file is presented, it may be presented as a compilation of the plurality of video files. For instance, in an example where ten 30-second video files are merged into one file, a single video file being five minutes long can be shown and played.

In some example implementations, the video application 300 may comprise a customization engine (not shown in the figure). The customization engine inserts the still frame into a pre-designed template. In one example, the video application 300 may provide a plurality of pre-designed template options to the user, and the user may choose a pre-designed template for the still frame.

In other implementations, where the user may use a plurality of video files, the video application 300 may comprise a merge engine to merge the plurality of video files into a merged video file. As a result, a single video file may contain all of the plurality of video files. For instance, if ten video files are associated with the still frame, a single video file can be created by merging the ten video files. Alternatively, a portion of the video file can be merged, e.g., four of the ten video files merged and six of the ten video files merged resulting in two merged video files.

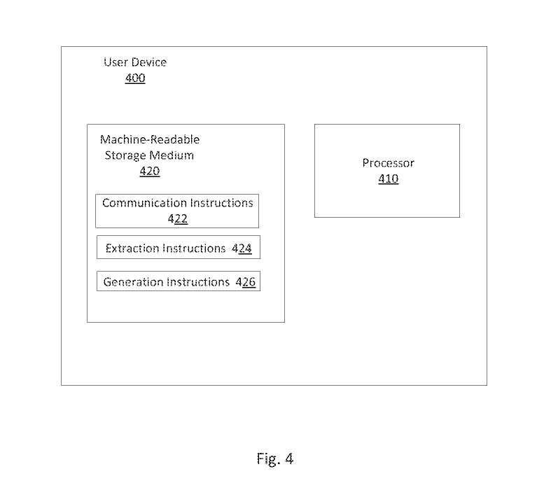

FIG. 4 is a block diagram illustrating aspects of an example computing device 400 that may be any of a variety of computing devices, such as a chip, an expansion card or a stand-alone device that interfaces with a peripheral device such as a workstation computer, a desktop computer, a laptop computer, a tablet or slate computer, a server computer, or a smart phone, among others. The computing device 400 includes a processor 410 and a machine-readable storage medium 420.

The processor 410 may be at least one central processing unit (CPU), at least one semiconductor-based microprocessor, other hardware devices or processing elements suitable to retrieve and execute instructions stored in the machine-readable storage medium 420, or combinations thereof. The processor 410 can include single or multiple cores on a chip, multiple cores across multiple chips, multiple cores across multiple devices, or combinations thereof. The processor 410 may fetch, decode, and execute instructions 422, 424, 426, among others, to implement various processing steps. As an alternative or in addition to retrieving and executing instructions, the processor 410 may include at least one integrated circuit (IC), other control logic, other electronic circuits, or combinations thereof that include a number of electronic components for performing the functionality of instructions 422, 424, 426. Accordingly, the processor 410 may be implemented across multiple processing units and instructions 422, 424, 426 may be implemented by different processing units in different areas of the computing device 400.

In one example implementation, the computer readable medium 420 may include program memory that includes programs and software such as an operating system, user detection software component, and any other application software programs. Further, the non-transitory computer readable medium 420 may participate in providing instructions to the processor 410 for execution. The non-transitory computer readable medium 420 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices.

The instructions 422, 424, 426, when executed by processor 410 (e.g., via one processing element or multiple processing elements of the processor) can cause processor 410 to perform processes, for example, the processes depicted in FIGS. 1-3.

Communication instructions 422 may cause the processor 410 to receive a portion of a video. Extraction instructions 424 may cause the processor 410 to extract a plurality of still frames from the received portion of the video. One still frame from the plurality of the still frames is selected by a user. Further, generation instructions 426 may cause the processor 410 to generate a trigger based on the still frame. In one implementation, there may be additional instructions that may cause the processor 410 to store the still frame along with the video file. Moreover, there may be additional instructions that may involve associating the video file with the trigger.

The computing device 400 may comprise a processing device and a non-transitory computer-readable medium. The machine-readable medium may comprise instructions that when executed cause the video application to conduct at least some of the functions described herein. The computer-readable medium may correspond to any typical storage device that stores machine-readable instructions, such as programming code, software, firmware, or the like. For example, the computer-readable medium may include one or more of a non-volatile memory, a volatile memory, and/or a storage device. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. In some implementations, the instructions may be part of an installation package that can be executed by the processing device. In this case, the computer-readable medium may be a portable medium such as a CD, DVD, or flash drive or a memory maintained by a server from which the installation package can be downloaded and installed. In other example implementations, the instructions may be part of an application or application already installed. Here, the computer-readable medium may include integrated memory such as a hard drive.

The processing device may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. The processing device may fetch, decode, and execute instructions stored on the computer-readable medium to implement the functionalities described above.

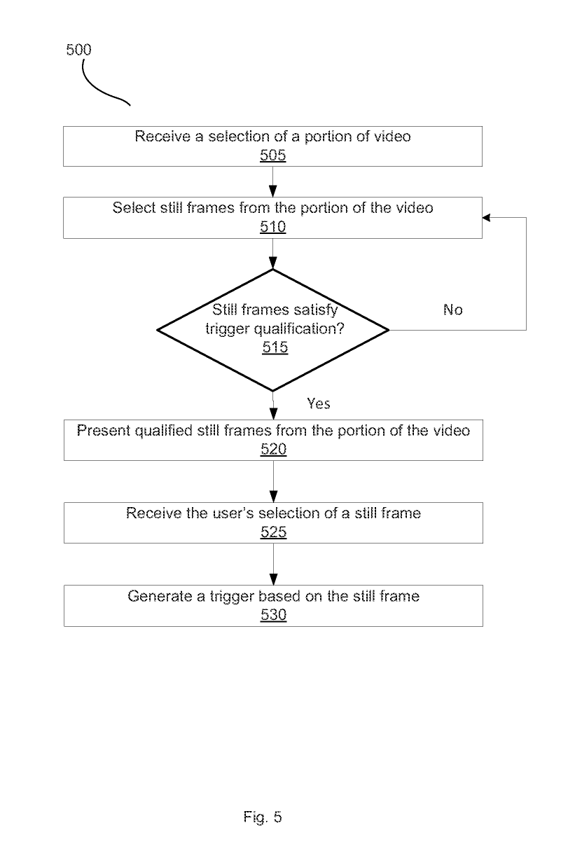

Turning now to the operation of the system 100, FIG. 5 depicts a process flow diagram 500 in accordance with an example implementation. It should be readily apparent that the processes depicted in FIG. 5 represent generalized illustrations, and that other processes may be added or the illustrated processes may be removed, modified, or rearranged in many ways. Further, it should be understood that the processes may represent executable instructions stored on memory that may cause a processing device to respond, to perform actions, to change states, and/or to make decisions, for instance. Thus, the described processes may be implemented as executable instructions and/or operations provided by a memory associated with the computing devices 120 and 170.

The illustrated process 500 begins at block 505, where a video application receives a user's selection of a portion of a video. In particular, in some example implementations, this process may involve a user creating an account and/or logging into the video application. For example, this process may involve receiving the user data (e.g., username, password) from the user. Once the user is logged in, the user may choose to upload personal content or allow the video application access the video files on the computing device. Further, the user selects a video and identifies a portion of the video, which is communicated to the video application. In one example, the user may be the owner of the video. In other example implementations, the video may be a video file acquired from another source.

At illustrated block 510, the video application selects a plurality of still frames (e.g., still images) from the selected portion of the video. Based on the selected still frames, at block 515, the video application may determine whether the still frames meet the requirements for at least one trigger qualification process associated with a trigger generation process. In the event that the still frames qualify for the trigger generation process, at block 520, the video application presents the still frames that meet the trigger qualification metric within the selected portion of the video. In the event that the still image does not satisfy the trigger qualification requirements, the process returns to block 510, and the video application selects still frames from the selected portion of the video. In an alternative implementation, the video application may alert the user to select a different portion of the video and may return to block 505.

At block 525, the video application receives the user's selection of a still frame from the still frames that meet the trigger qualification metric. More specifically, the video application may provide a user interface for the user to make a frame selection. At block 530, the video application generates a trigger based on the selected still frame. In one example implementation, this process may involve storing the trigger in a database along with the video file that the still frame is extracted from. As discussed in detail above with respect to FIG. 1, the trigger may comprise characteristics of the still frame, and may associates the video file with the still frame.

While the above disclosure has been shown and described with reference to the foregoing examples, it should be understood that other forms, details, and implementations may be made without departing from the spirit and scope of the disclosure that is defined in the following claims.

What is claimed is:

1. A processor-implemented method comprising:
determining whether each of a plurality of still frames satisfies at least one trigger qualification process for a trigger generation process;
presenting for selection still frames from the plurality of still frames if the still frames satisfy the at least one trigger qualification process for a trigger generation process;
receiving a selection of a still frame from among the presented still frames; and
performing the trigger generation process on the selected still frame to generate a trigger for the selected still frame.

2. The method of claim 1, further comprising associating the trigger with the video in a database such that the video is retrieved from the database using the trigger.

3. The method of claim 1, wherein the trigger comprises encoded information derived from characteristics of the selected still frame.

4. The method of claim 1, wherein the trigger qualification process comprises determining a plurality of characteristics of the still frame and comparing the determined characteristics with one or more thresholds.

5. The method of claim 1, further comprising:
eliminating still frames from the plurality of still frames if the still frames determined to fail the at least one trigger qualification process.

6. The method of claim 5, further comprising:
presenting a representation of the video to a user;
receiving a selection of a portion of the video from the user; and
extracting the plurality of still frames from the selected portion of the video.

7. The method of claim 5, wherein the plurality of still frames are automatically extracted from the video.

8. The method of claim 1, further comprising:
identifying a plurality of videos from a video database, including the video;
displaying respective representations of each of the retrieved videos for selection; and
presenting a selection of the video.

9. A method of claim 1, further comprising receiving a selection of a predesigned template and inserting the selected still frame into the selected template.

10. A system comprising:
a quality engine to perform a qualification process for a trigger generation process;
an extraction engine to extract still frames from the video;
a display engine to display, in a graphical user interface (GUI) for selection, still frames qualified by the qualification process;
a communication engine to receive a selection of one of the displayed still frames via the GUI; and
a generation engine to perform the trigger generation process on the selected still frame to generate a trigger for the selected still frame.

11. The system of claim 10, wherein the quality engine is to determine a plurality of characteristics of the still frame and to compare the determined characteristics with one or more thresholds to avoid sparse images, dark images, images with repeated and identical features, blurred images or reflective images.

12. The system of claim 10, wherein the communication engine is to receive a selection of a portion of the video, and wherein the quality engine is to identify the still images from the selected portion of the video.

13. A non-transitory computer-readable medium comprising instructions which, when executed, cause a device to:
extract a plurality of still frames from a selected portion of a video;
determine whether each of the plurality of still frames satisfies at least one trigger qualification process for a trigger generation process;
present for selection still frames from the plurality of still frames determined to satisfy the at least one trigger qualification process;
receive a selection of a still frame from among the presented still frames; and
perform the trigger generation process on the selected still frame to generate a trigger for the selected still frame.
